(19) United States
(12) Patent Application Publication
(10) Pub. No.: US 2004/0158509 A1
(43) Pub. Date: Aug. 12, 2004

(54) Flexible window-based auditing method

(76) Inventor: Chih-Hung Chien, Taoyuan (TW)

Correspondence Address: BIRCH STEWART KOLASCH & BIRCH, PO BOX 747, FALLS CHURCH, VA, 22040-0747, US

(21) Appl. No.: 10/360,617

(22) Filed: Feb. 10, 2003

(51) Int. Cl. G06F 17/60

(52) U.S. Cl. 705/30

(57) ABSTRACT

A flexible window-based auditing method that first defines the types of all auditing events, and automatically generates the corresponding items of an auditing event in a Web system when the auditing event occurs. It allows the system administrators to flexibly configure the members and hints in a window-based manner, send notifications according to the settings, and manage the processing of the items of the auditing events.

### BACKGROUND OF THE INVENTION

1. Field of Invention

The invention relates to an auditing method, and more particularly to a flexible window-based auditing method that dynamically displays windows in a web system for staff hint configuration, hint alert notification and auditing process management.

2. Related Art

In recent years, the increasing popularity and rapid advance in Internet technology and network communication technology has greatly affected the operation of enterprises. The tasks of individual persons, the operation of organizations and the interaction between organizations change due to the digitalization of information and knowledge. The members of an organization used to communicate with one another by transferring documents back and forth. Since these documents are composed manually, their composition is time-consuming and they are difficult to maintain. The traditional document auditing method involves determining the responsible department manually and transferring the documents. This usually results in mistakes and the loss of documents. Since auditing progress management requires oral inquiry, it is difficult to evaluate the effect of the execution and track the progress of the tasks. As a consequence, for enterprises the traditional auditing method makes operations inefficient, makes of the evaluation of cost more difficult and makes process analysis and evolution ineffective.

In addition, with the growth of enterprise organizations and the increasing complexity of the operation models among enterprises, the auditing method that used to be employed in a single enterprise cannot satisfy the requirements of modern enterprise applications. Each auditing process may face some cross-country, cross-enterprise, cross-department and cross-unit difficulties, and therefore the auditing process should be flexible enough to immediately adjust for these requirements. For these kinds of cases, it is difficult to achieve this goal with the traditional method. As a consequence, it is necessary to develop a simple and convenient method to overcome this problem.

### SUMMARY OF THE INVENTION

In view of the aforesaid disadvantages, a flexible window-based auditing method is proposed by the invention.

The proposed flexible auditing method comprises the following steps. First, the system administrators define the types of auditing events. The system determines whether the defined auditing events occur. If yes, the system automatically generates the items of the auditing event. Then the predetermined person in charge of this auditing event configures the items of the auditing event and executes them (including providing the hints, setting up, processing and managing) after configuration. When the item of the auditing event has been finished, the system automatically deletes this item of the auditing event.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is a flowchart of the proposed flexible window-based auditing method.

FIG. 2 is a flowchart of defining the types of auditing events of the proposed flexible window-based auditing method.

FIG. 3 is a flowchart of the execution of the proposed flexible window-based auditing method.

### DETAILED DESCRIPTION OF THE INVENTION

The invention proposes a flexible window-based auditing method that provides the administrators of the system with the definitions of auditing events. When some abnormal events occur, the system automatically generates corresponding items of the auditing events based on the definitions of the events, and executes the auditing process in a window-based manner. In addition to allowing the person in charge of these items of auditing events to flexibly execute the auditing process and configure the members and hints, the proposed method also automatically issues the notifications to the members who are expected to audit according to the configuration, and manages all items of the auditing events by monitoring the status of the process.

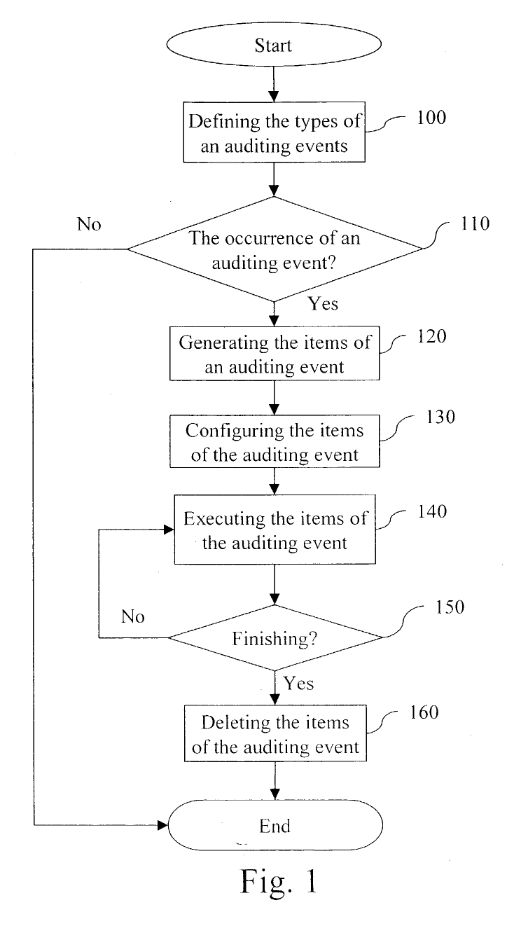

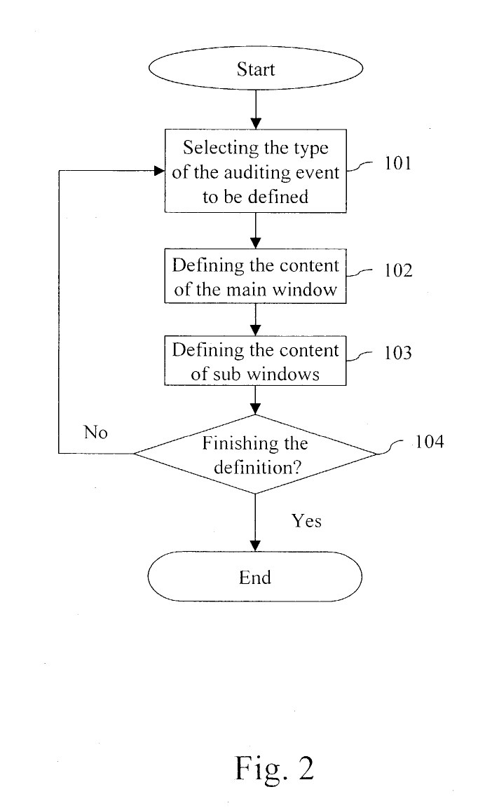

FIG. 1 shows the main process of the proposed flexible window-based auditing method. First, the system administrators define all auditing events by categorizing possible auditing events according to their attributes (Step 100). In essence, these definitions comprise the definitions for main and sub windows, and the details of defining are described in FIG. 2. When one auditing event occurs (Step 110), the system generates the corresponding item of the auditing event according to the type of auditing event (Step 120). Then the system sends the notification to the person in charge based on the content of the main window so s/he knows to log onto the Web site to configure the item of the audit event (Step 130). The system executes processing of the item of the auditing event according to the content of the configuration (Step 140). The detailed operations are described in the next paragraph. If not all items of the auditing event have been finished, step 140 is continued. Otherwise, when all processes of all items of the auditing event have been finished (Step 150), the system deletes all items of the auditing event from the Web site (Step 160) and terminates the auditing process.

Refer to FIG. 2 for the process of defining the types of auditing events. Since there are many types of auditing events in an enterprise, the invention allows the system administrators to configure the auditing events in advance. First, the system administrators select the type of auditing event (Step 101) and configure the content of the main and sub windows according to the type of auditing event. Defining the content of the main window (Step 102) involves establishing the list of persons who are notified when the auditing event occurs and constructing the relationship between sub windows and the main window to finish the job in the main window. Defining the content of the sub windows (Step 103) is to configure the list of persons in charge and the content of notifications for each sub window mentioned (Step 102). After the definitions of all main and sub windows have been finished, the process of defining the types of auditing events terminates. If the system administrators want to define the types of other auditing events, they execute Step 101 again.

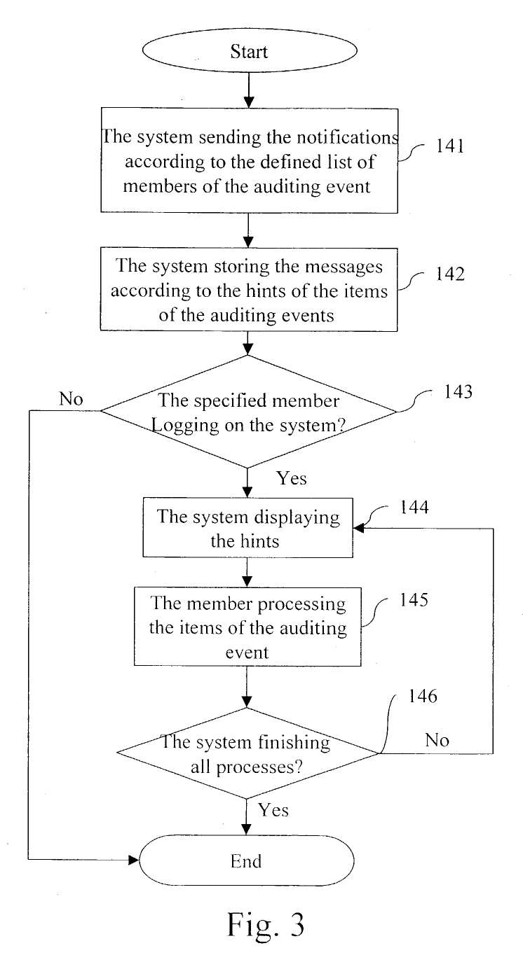

Refer to FIG. 3 for the detailed processes of the items of the auditing events. When the items of auditing events are generated, the system notifies all members mentioned in the definitions of the types of auditing events (Step 141) mainly by E-mail. The system stores the predefined hints into all members' storage and shows these hints when the members log on (Step 142). Then the system determines whether these members have logged onto the Web site (Step 143). If yes, the system shows the content in the members' predefined storage to give hints to these members (Step 144).

With the invention, system administrators can revise and define the needed auditing events according to the practical operations of the enterprises. Therefore the system simplifies the auditing processes and greatly improves the efficiency of the auditing operations by effectively managing the auditing processes. In addition, the employment of the invention to track the progress of the auditing processes saves human management costs of the enterprises and saves the time and cost needed to deliver documents back and forth.

From the above analysis, the advantages of the proposed flexible window-based auditing method are as follows:

1. Simplify the management of auditing events by executing the predefined types of events and actively trigger them into the Web site.

2. Increase the flexibility of the auditing process by allowing the members to configure and process the items of the auditing event according to practical requirements.

3. Increase the efficiency of the auditing operations and reduce errors by active hints in windows and E-mail.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A flexible window-based auditing method which is used in the internal and external of enterprises for managing the auditing process, comprising:
defining the types of an auditing events;
the auditing event occurring;
generating items of the auditing event;
configuring the items of the auditing event;
executing the items of the auditing event; and
deleting the items of the auditing event.

2. The method of claim 1, wherein the steps of defining the types of the auditing events comprises:
selecting the type of the auditing event to be defined;
defining the content of the main window;
defining the content of the sub window; and
finishing the definition.

3. The method of claim 2, wherein defining the content of the main window is to define the relationship between the main and sub windows, and configure the persons in charge of the main window.

4. The method of claim 2, wherein defining the content of the sub windows is to configure at least one person in charge of the sub windows.

5. The method of claim 1, wherein executing the items of the auditing event comprise:
sending notifications to the specified members of the items of the auditing event;
storing the messages according to the configuration of the hints of the items of the auditing event;
the member logging on the system;
displaying the messages of hints;
the members processing the auditing; and
finishing all processes and terminating.

6. The method of claim 5, wherein the notifications are sent to the members by E-mail.

7. The method of claim 5, wherein the content of the hints comprises the hints of registration and the functional items.
